(19) United States
(12) Patent Application Publication
(10) Pub. No.: US 2008/0163091 A1
(43) Pub. Date: Jul. 3, 2008

(54) Filtering Data

(75) Inventor: Daniela K. Busse, San Francisco, CA (US)

Correspondence Address: FISH & RICHARDSON, P.C., PO BOX 1022, MINNEAPOLIS, MN, 55440-1022, US

(73) Assignee: SAP AG

(21) Appl. No.: 11/618,625

(22) Filed: Dec. 29, 2006

(51) Int. Cl. G06F 3/048

(52) U.S. Cl. 715/771

(57) ABSTRACT

Systems and techniques for filtering data. In one aspect, an article includes one or more machine-readable media storing instructions operable to cause one or more machines to perform operations. The operations include rendering at least a portion of a first collection of data in a first visual rendition that includes a first interactive element, receiving a user selection of a first filter as a consequence of user interaction with the first interactive element, filtering the first collection of data to yield a second collection of data, and rendering at least a portion of the second collection of data in a second visual rendition, the second visual rendition comprising a description of the first filter.

### BACKGROUND

This disclosure relates to the filtering of data.

Filtering a set of data redacts the information content of a set of data to yield a collection of data that satisfies one or more criteria. For example, filtering can yield a collection of data that have properties or relations designated by one or more predicates. Filtering can be used in a data pipeline to process an input data stream into a relatively smaller output data stream in accordance with the one or more predicates.

### SUMMARY

Systems and techniques for the filtering of data are described. In one aspect, a display includes a first visual rendition of at least a portion of a first collection of data, and a second visual rendition of at least a portion of the second collection of data. The first visual rendition includes a first interactive element to receive a user selection of a first filter to be used to filter the first collection of data to yield a second collection of data. The second visual rendition comprises a description of the first filter.

This and other aspects, can include one or more of the following features. The first visual rendition can include a description of a filter that was used to filter a collection of data to yield the first collection of data. The visual rendition can include a graph. The interactive element can include a visual element in the graph. For example, the visual element in the graph can include a text label or a representative element that represents a value or a variation of a variable. The first interactive element can be logically related to an attribute of a predicate of the first filter. For example, the first interactive element can include a description of a variable and the attribute of the predicate of the first filter can include the described variable. The first interactive element can be logically related to a value of a predicate of the first filter. For example, the first interactive element can include a label and the predicate of the first filter can include the label.

The second visual rendition can include a tabular rendition. The description of the first filter can include a description of a value of a predicate of the first filter or a description of an attribute of a predicate of the first filter. The can also include a third visual rendition of at least a portion of a third collection of data. The third collection of data can be yielded by filtering the second collection of data using a second filter. The user selection received by the first interactive element can select the first filter and the second filter.

In another aspect, an article includes one or more machine-readable media storing instructions operable to cause one or more machines to perform operations. The operations include rendering at least a portion of a first collection of data in a first visual rendition that includes a first interactive element, receiving a user selection of a first filter as a consequence of user interaction with the first interactive element, filtering the first collection of data to yield a second collection of data, and rendering at least a portion of the second collection of data in a second visual rendition, the second visual rendition comprising a description of the first filter.

This and other aspects can include one or more of the following features. The portion of the first collection of data can be rendered in a graph. The user selection can be received as a consequence of user interaction with a visual element in the graph. For example, the user selection can be received as a consequence of user interaction with a text label in the graph or as a consequence of user interaction with a representative element that represents a value or a variation of a variable.

The first interactive element can be logically related to a value of a predicate of the first filter. For example, the first interactive element can include a description of a variable and the value of the predicate of the first filter can include the described variable. The first interactive element can be logically related to an attribute of a predicate of the first filter. For example, the first interactive element can include a label and the attribute of the predicate of the first filter can include the label.

The operations can also include filtering the second collection of data to yield a third collection of data and rendering at least a portion of the third collection of data in a third visual rendition. The at least the portion of the first collection, the at least the portion of the second collection, and the at least the portion of the third collection can be rendered on a same visual display. A user selection of the third filter can be received. For example, the user selection of the third filter can be received as a consequence of the user interaction with the first interactive element.

In another aspect, a method includes receiving a collection of data, filtering the collection to yield a once-filtered collection of data, rendering at least a portion of the once-filtered collection of data on a display, filtering the once-filtered collection of data to yield a twice-filtered collection of data, rendering at least a portion of the twice-filtered collection of data on the display, filtering the twice-filtered collection of data to yield a thrice-filtered collection of data, and rendering at least a portion of the thrice-filtered collection of data on the display.

This and other aspects can include one or more of the following features. At least a portion of the once-filtered collection, the twice-filtered collection, or the thrice-filtered collection can be rendered in a graphical display. At least a portion of the once-filtered collection or the twice-filtered collection can be rendered in a first visual rendition that includes a first interactive element. A user selection of a first filter can be received as a consequence of user interaction with the first interactive element. At least a portion of the twice-filtered collection or the thrice-filtered collection can be rendered in a second visual rendition that includes a description of the first filter.

The details of one or more implementations are set forth in the accompanying drawings and the description below. Other features and advantages will be apparent from the description and drawings, and from the claims.

### DESCRIPTION OF DRAWINGS

FIG. 1 is a schematic illustration of the filtering of a data collection.

FIG. 2 is a schematic illustration of a collection of predicates that can be used for the filtering of a data collection FIG. 3 is a flow chart of a process for the filtering of data.

FIG. 4 shows one implementation of a display screen that includes an interactive element that can receive a selection of a filter.

FIG. 5 illustrates operational activities performed in the display of a display screen that renders a rendition of at least a portion of a filtered data stream.

FIG. 6 illustrates one implementation of a display screen in which a rendition of a filtered data stream can act as an interactive element to receive a selection of a filter.

FIG. 7 illustrates operational activities performed in the display of a display screen that renders a rendition of at least a portion of a twice-filtered data stream.

FIG. 8 illustrates one implementation of display screen that includes an interactive element to receive a selection of a filter.

FIG. 9 illustrates operational activities performed in the display of a display screen that renders a rendition of at least a portion of a thrice-filtered data stream.

FIG. 10 shows one implementation of display screen of FIG. 9.

FIGS. 11 and 12 show other display screens on which filtered data can be rendered.

Like reference symbols in the various drawings indicate like elements.

### DETAILED DESCRIPTION

FIG. 1 is a schematic illustration of the filtering of a data collection 105 that includes a first amount of data. Data collection 105 can be a database or other collection of information. For example, data collection 105 can be a data table, as shown. As another example, data collection 105 can be a collection of enterprise data that includes a hierarchical arrangement of a collection of business objects that abstract the entities of a business or other enterprise.

Data collection 105 can be represented as a data stream 110 that is filtered by a filter 115 to yield a filtered data stream 120. Filtered data stream 120 does not include the entire information content of data stream 110. Instead, filtered data stream 120 includes some fraction of the information content of data stream 110. For example, filtered data stream 120 can be the fraction of data stream 110 that possesses properties or relations designated by one or more predicates. Filtered data stream 120 can thus be subset of data stream 110 in that all the data in filtered data stream 120 can also be found in data stream 110. The relative sizes of the information content of data streams 110, 120 is illustrated by the relative size of the arrows representing data streams 110, 120.

Filtered data stream 120 can be used in a variety of different data processing activities. For example, filtered data stream 120 can be processed to render at least some of the information content of filtered data stream 120 for a human user on an output device 125. Output device 125 can include one or more visual, auditory, and/or mechanical output devices. For example, output device 125 can include a computer monitor, a display screen of at personal digital assistant, or the like. Data in filtered data stream 120 can be output in variety of different ways, in accordance with the nature of output device 125. For example, information in filtered data stream 120 can be rendered in a graphical rendition 130 and a tabular rendition 135, as discussed further below. The entire information content of filtered data stream 120 need not be rendered in graphical rendition 130 or tabular rendition 135. Instead, graphical rendition 130 or tabular rendition 135 can render a subset of the data of filtered data stream 120 and/or summaries of the information content of filtered data stream 120. The summaries can be prepared, e.g., by performing mathematical operations on the data of filtered data stream 120.

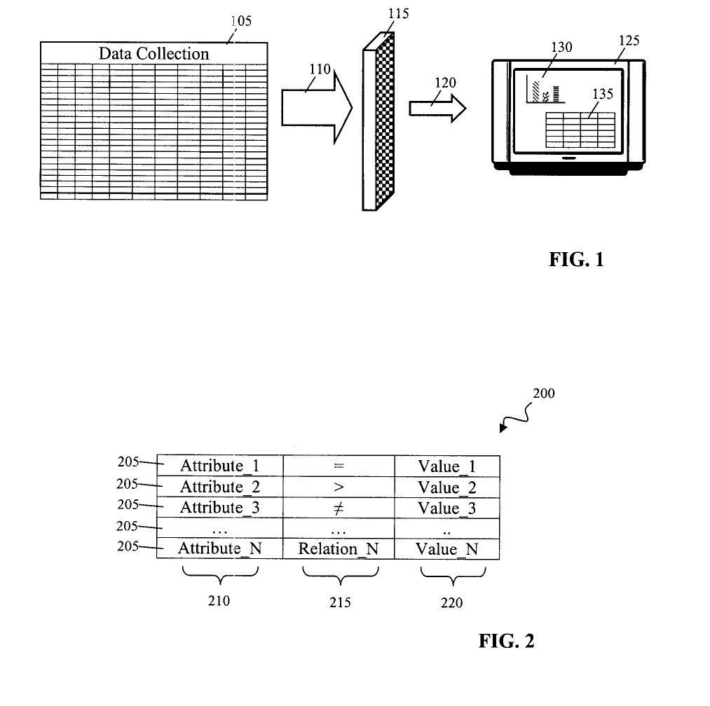

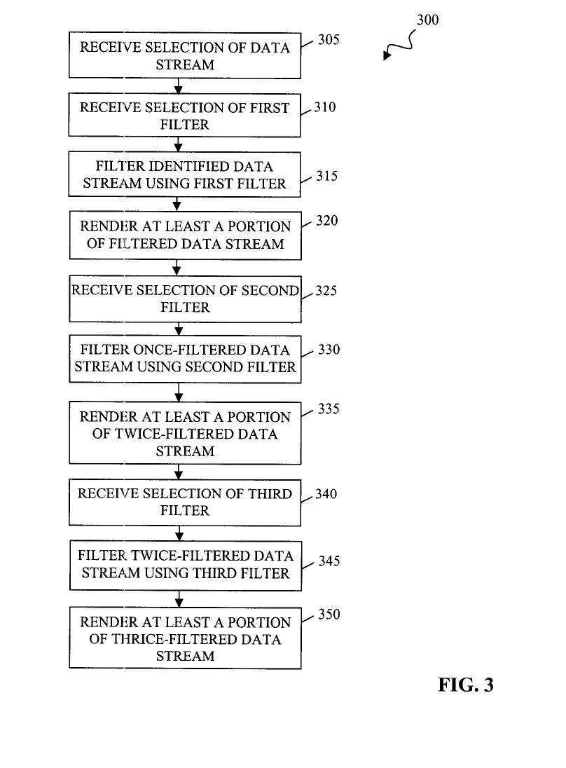

FIG. 2 is a schematic illustration of a collection 200 of predicates 205 that can be used for the filtering of a data collection. Each predicate 205 in collection 200 specifies that an attribute 210 have a relation 215 with one or more values 220. Attributes 210 can specify a portion of a collection of data. For example, attribute 210 can be, e.g., a column in a data table, a field in a record, an entry in an array, an attribute in a data object, or the like. Relation 215 describes the association between an attribute 210 and a value 220. For example, relation 215 can specify that a binary relation exists, such as an ordered relation. Values 220 specify a characteristic, such as a numerical value, string of text, or the like. The predicates 205 in a collection 200 can be used to implement a database query or other filter expression for the filtering of a data collection.

A single filter, such as filter 115 (FIG. 1), can use multiple predicates 205 for the filtering of a data collection. Also, multiple filters with different predicates 205 can be used in series to achieve a comparable filtering of a data collection. Thus, for the sake of convenience, both single filters and multiple filters are referred to herein in the singular.

FIG. 3 is a flow chart of a process 300 for the filtering of data. Process 300 can be performed by one or more devices in accordance with the logic of one or more sets of machine readable instructions. For example, process 300 can be performed by a computer executing software.

The system performing process 300 can receive a selection of a data stream at 305. The selection can be made by presenting a user with an interactive elements and receiving an identification of a selected data stream over the interactive element. For example, the selection can be received from a user who selects the name of a data stream from a list of data streams on a visual display. As another example, the identity of a data stream can be inferred from other user interaction with the system performing process 300.

The system performing process 300 can also receive a selection of a first filter at 310. The selection of the first filter can be received as a consequence of user interaction with an interactive element displayed on a display screen. For example, a user can select the first filter from a collection of predefined filters, e.g., by double clicking on an identifier of the first filter, using a pull-down menu to select an identifier of the first filter, or the like. Predefined filter have a filter expression (including, e.g., properties, relations and/or predicates) that has already been established. In some implementations, the receipt of the selection of the first filter can include the definition of a new filter by a user who interacts with a filter expression builder or the like.

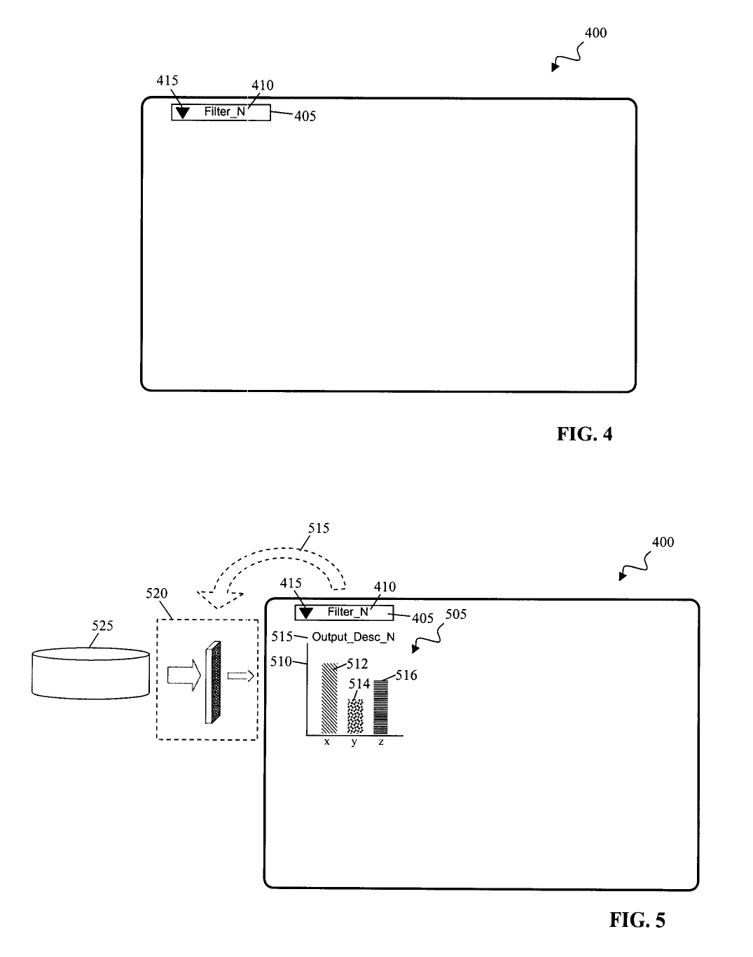

FIG. 4 shows one implementation of a display screen 400 that includes an interactive element 405 that can receive a selection of a first filter from amongst a collection of predefined filters. Interactive element 405 can be a pull-down menu that includes an identifier of a currently selected filter 410 and a pull-down element 415. In operation, a user can interact with pull-down element 415 (e.g., by left-clicking on pull-down element 415 using a mouse) to view a list of filter descriptors. The user can then interact with the list to select a desired filter (e.g., by clicking on the name of the first filter). Currently selected filter identifier 410 can then display the descriptor of the desired filter.

Returning to FIG. 3, the system performing process 300 can also filter the identified data stream using the first filter at 315. This filtering can thus yield a filtered data stream that constitutes the fraction of the information content of the selected data stream. The system performing process 300 can also render at least a portion of this filtered data stream at 320. In some implementations, the portion of this filtered data stream can be rendered in a display screen that includes an interactive element used in the identification of the first filter at 310.

FIG. 5 illustrates operational activities performed in the display of a display screen 400 that renders interactive element 405 and a rendition 505 of at least a portion of a filtered data stream. Filtered data stream rendition 505 includes a graph 510 and an output descriptor 515. Graph 510 is a diagram that represents the value or variation of a variable relative to the value or variation of one or more other variables. The value or variation of a variable in graph 510 can be represented using one or more representative elements, such as bars, points, lines, line segments, curves, or areas. For example, in the illustrated graph 510, a bar representative element 512 represents the value of a variable “x,” a bar representative element 514 represents the value of a variable “y,” and a bar representative element 516 represents the value of a variable “z.”

Output descriptor 515 describes the portion of a filtered data stream that is rendered in rendition 505. Output descriptor 515 can describe the rendered portion of a filtered data stream based on an identifier or other description of the source data stream, an identifier or other description of the filter that yields the filtered data stream, combinations of these and other descriptions, and the like. For example, output descriptor 515 can identify the rendered portion of a filtered data stream by describing one or more predicates used in filtering a data set. The predicates can be described using the relation between an attribute and a value specified by the predicate. For example, if a predicate specifies that a “salesperson_ID” attribute be equal to the value “192919,” output descriptor 515 can describe that the rendered portion of a filtered data stream as “Sales by Employee 192919”. In some implementations, predicates can be described in a semantic format that is convenient for human users. For example, if the employee number “192919” is associated with an employee named “Joe Smith,” output descriptor 515 can describe that the rendered portion of a filtered data stream as “Sales by Joe Smith.”

In operation, in response to a user selection of a desired filter by interacting with interactive element 405, an identification of the desired filter can be returned to a data processing device at 520. The data processing device can use the identified filter in filtering 525 a data collection 530. At least a portion of the filtered data stream yielded by filtering 525 can be rendered in rendition 505 in accordance with the logic of one or more sets of machine-readable instructions. The instructions can specify the representation of the value or variation of a variable relative to the value or variation of one or more other variables in graph 510 and the description of the rendered portion of the filtered data stream in output descriptor 515. Returning to FIG. 3, the system performing process 300 can also receive a selection of a second filter at 325. The selection of the second filter can be received as a consequence of user interaction with an interactive element displayed on a display screen.

For example, a user can select the second filter from a collection of predefined filters or the user can define a new filter by interacting with a filter expression builder. In some implementations, the selection of the second filter can be received as a consequence of user interaction with an interactive element displayed the same display screen that displayed the interactive element over which the selection of the first filter was received at 310.

In some implementations, the interactive element over which the selection of the second filter in received can be a rendition of a filtered data stream. The interactive element can be the rendition of at least a portion of the filtered data stream that was rendered at 320.

Moreover, in some implementations, the portion of the rendition of a filtered data stream with which a user interacts can have a logical relationship with the filter selected by interacting with that portion. For example, when the rendition of a filtered data stream includes a graphical element, the description provided by a graphical element label can play a role in a predicate of a filter selected by interacting with that label. For example, a value described by an axis label can be the value in a predicate of the filter selected by interacting with that label. As another example, when the rendition of a filtered data stream includes a graph, the variable whose value or variation is represented by a representative element can play a role in a predicate of a filter selected by interacting with that representative element. For example, the variable can be the attribute in a predicate of a filter.

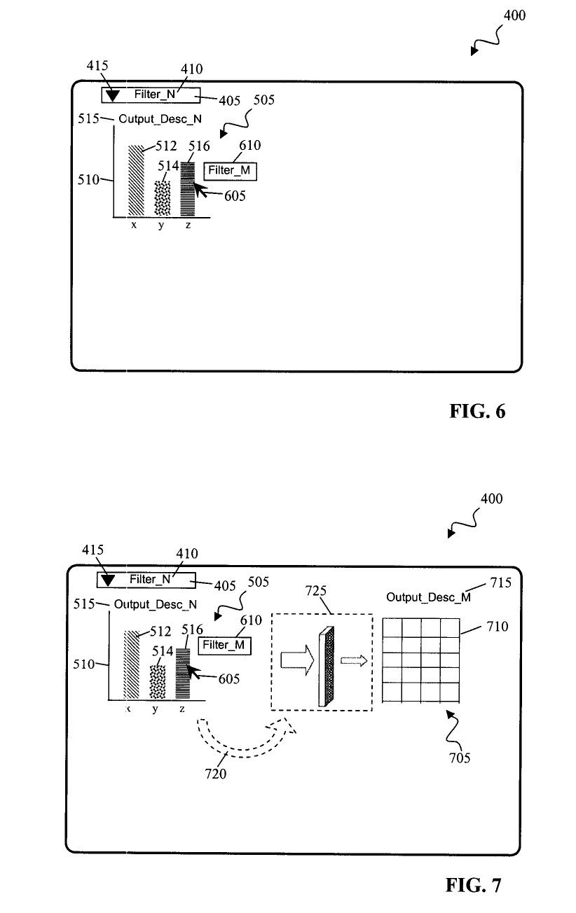

FIG. 6 illustrates one implementation of display screen 400 in which a rendition 505 of a filtered data stream can act as an interactive element and receive a user identification of a second filter. Moreover, the variable whose value or variation is represented by a representative element has a logical relationship to a predicate of the selected filter.

In particular, user interaction with any of representative elements 512, 514, 516 can evoke a predefined filter. A user can interact with representative elements 512, 514, 516, e.g., by placing a cursor icon 605 on representative elements 512, 514, 516. The predefined filter evoked by interaction with representative elements 512, 514, 516 can have a logical relationship to the variable whose value or variation is represented by representative elements 512, 514, 516. For example, the predefined filter evoked by interaction with representative elements 512 can include a predicate that specifies that an attribute have a value “x.” The predefined filter evoked by interaction with representative elements 514 can include a predicate that specifies that the same attribute have a value “y.”. The predefined filter evoked by interaction with representative elements 516 can include a predicate that specifies that the same attribute have a value “z.”. The attribute can be represented along an axis in a graph 510. The evocation of a filter can include the display of a description 610 of the evoked filter, along with allowing a user selection of the evoked filter using a mouse click or the like.

Returning to FIG. 3, the system performing process 300 can also filter the once-filtered data stream using the second filter at 330. This filtering can thus yield a twice-filtered data stream that constitutes the fraction of the identified data stream that possesses properties or relations designated by predicates of the first filter and by predicates of the second filter. The system performing process 300 can also render at least a portion of this twice-filtered data stream at 335. In some implementations, the portion of this twice-filtered data stream can be rendered in a display screen that includes the interactive element over which the identification of the second filter was received at 325.

FIG. 7 illustrates operational activities performed in the display of a display screen 400 that renders interactive element 405, rendition 505, and a rendition 705 of at least a portion of a twice-filtered data stream. Twice-filtered data stream rendition 705 includes a table 710 and an output descriptor 715. Table 710 is a display of information in an ordered arrangement of cells in rows and columns. The cells of table 710 can be grouped, segmented, merged, and/or displayed in a variety of ways. Additionally, table 710 can include metadata, annotations, header, footer or other ancillary features (not shown).

Output descriptor 715 describes the portion of the twice-filtered data stream that is rendered in rendition 705. Output descriptor 715 can describe the rendered portion of a twice-filtered data stream based on an identifier or other description of the source data stream, an identifier or other description of the second filter, combinations of these and other descriptions, and the like. For example, output descriptor 715 can describe the rendered portion of a twice-filtered data stream by describing one or more predicates used in filtering a data set. The predicates can be described using the relation between an attribute and a value specified by the predicate. For example, if a predicate specifies that a “customer_ID” attribute be equal to the value “13907,” output descriptor 715 can identify that the rendered portion of a twice-filtered data stream as “Sales to Customer 13907.” In some implementations, predicates can be described in a semantic format that is convenient for human users.

In operation, in response to a user selection of a desired second filter by interacting with filtered data stream rendition 505, an identification of the desired second filter can be returned to a data processing device at 720. The data processing device can use the second filter in filtering 725 the once-filtered data rendered in rendition 505. At least a portion of the twice-filtered data stream yielded by filtering 725 can be rendered in rendition 705 in accordance with the logic of one or more sets of machine-readable instructions. The instructions can specify the ordering of the arrangement of cells in rows and columns in table 710 and the description of the rendered portion of the twice-filtered data stream in output descriptor 715.

Returning to FIG. 3, the system performing process 300 can also receive a selection of a third filter at 340. The selection of the third filter can be received as a consequence of user interaction with an interactive element displayed on a display screen. For example, a user can select the third filter from a collection of predefined filters or the user can define a new filter by interacting with a filter expression builder. In some implementations, the selection of the third filter can be received as a consequence of user interaction with an interactive element displayed the same display screen that displayed the interactive element over which the selection of the second filter was received at 325. Also, the interactive element over which the selection of the third filter in received can be a rendition of a filtered data stream. For example, the interactive element can be the rendition of at least a portion of the twice-filtered data stream that was rendered at 335.

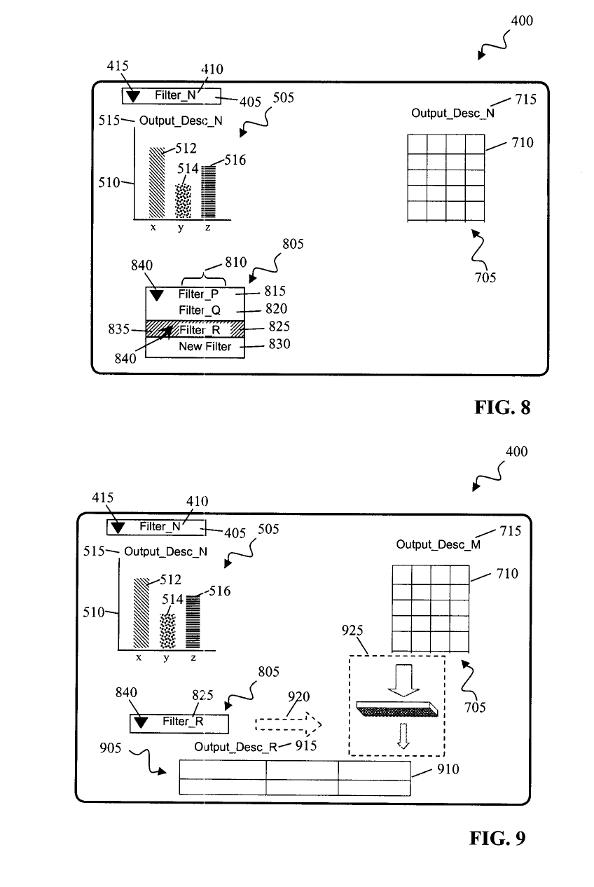

FIG. 8 illustrates one implementation of display screen 400 that includes an interactive element 805 that can receive a selection of a third filter from amongst a collection of predefined and undefined filters. Interactive element 805 can be a pull-down menu that includes a collection 810 of filter identifiers. The identifiers in filter identifier collection 810 include identifiers of predefined filters 815, 820, 825 and an identifier 830 indicating that a new filter is to be created. Interactive element 805 can also include a graphical device 835 that indicates the currently selected third filter. As illustrated, the currently selected third filter is identified by identifier 825.

In operation, a user can interact with interactive element 805 (e.g., by left-clicking on pull-down element 840 using a mouse) to view a filter identifier collection 810. The user can then interact with filter identifier collection 810 to select a desired third filter (e.g., by positioning a cursor 840 over the desired third filter in collection 810). Graphical device 835 can then render the identifier of the currently selected third filter.

Returning to FIG. 3, the system performing process 300 can also filter the twice-filtered data stream using the third filter at 345. This filtering can thus yield a thrice-filtered data stream that constitutes the fraction of the identified data stream that possesses properties or relations designated by predicates of the first filter, by predicates of the second filter, and by predicates of the third filter. The system performing process 300 can also render at least a portion of this thrice-filtered data stream at 350. In some implementations, the portion of this thrice-filtered data stream can be rendered in the same display screen that includes the interactive element over which the identification of the third filter was received at 340.

FIG. 9 illustrates operational activities performed in the display of a display screen 400 that renders interactive element 405, rendition 505, rendition 705, and a rendition 905 of at least a portion of a thrice-filtered data stream. Thrice-filtered data stream rendition 905 includes; a table 910 and an output descriptor 915. Output descriptor 915 describes the portion of the thrice-filtered data stream that is rendered in rendition 905. Output descriptor 915 can describe the rendered portion of a thrice-filtered data stream based on an identifier or other description of the source data stream, an identifier or other description of the third filter, combinations of these and other descriptions, and the like. For example, output descriptor 915 can describe the rendered portion of a thrice-filtered data stream by describing one or more predicates used in filtering a data set. The predicates can be described using the relation between an attribute and a value specified by the predicate. For example, if a predicate specifies that a “date” attribute be greater that “12312005,” output descriptor 915 can identify that the rendered portion of a thrice-filtered data stream as “Sales since 12312005.” In some implementations, predicates can be described in a semantic format that is convenient for human users, such as “Sales since Dec. 31, 2005.”

In operation, in response to a user selection of a desired third filter by interacting with interactive element 805, an identification of the desired third filter can be returned to a data processing device at 920. The data processing device can use the identified third filter in filtering 925 the thrice-filtered data rendered in rendition 905. At least a portion of the thrice-filtered data stream yielded by filtering 925 can be rendered in rendition 905 in accordance with the logic of one or more sets of machine-readable instructions. The instructions can specify the ordering of the arrangement of cells in rows and columns in table 910 and the description of the rendered portion of the thrice-filtered data stream in output descriptor 915.

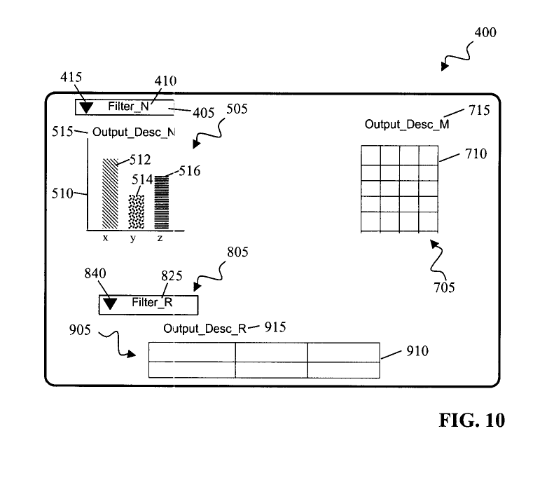

FIG. 10 shows one implementation of display screen 400 as it stands in FIG. 9, but representation of operational activities (such as filtering 725, 925) have been omitted for the sake of clarity. Instead, examples of various visual elements that can be rendered on a single display screen 400 are shown.

The illustrated implementation of display screen 400 includes renditions 505, 705, 905 of various redactions of the information content of a data stream. As discussed above, the information content of renditions 505, 705, 905 is subject to increasingly strict criteria as additional filtering is performed. The filtering can be described by the rendition of descriptors of currently selected filters 410, 825 on display screen 400. As another example, the filtering can be described by the rendition of output descriptors 515, 715, 915 on display screen 400.

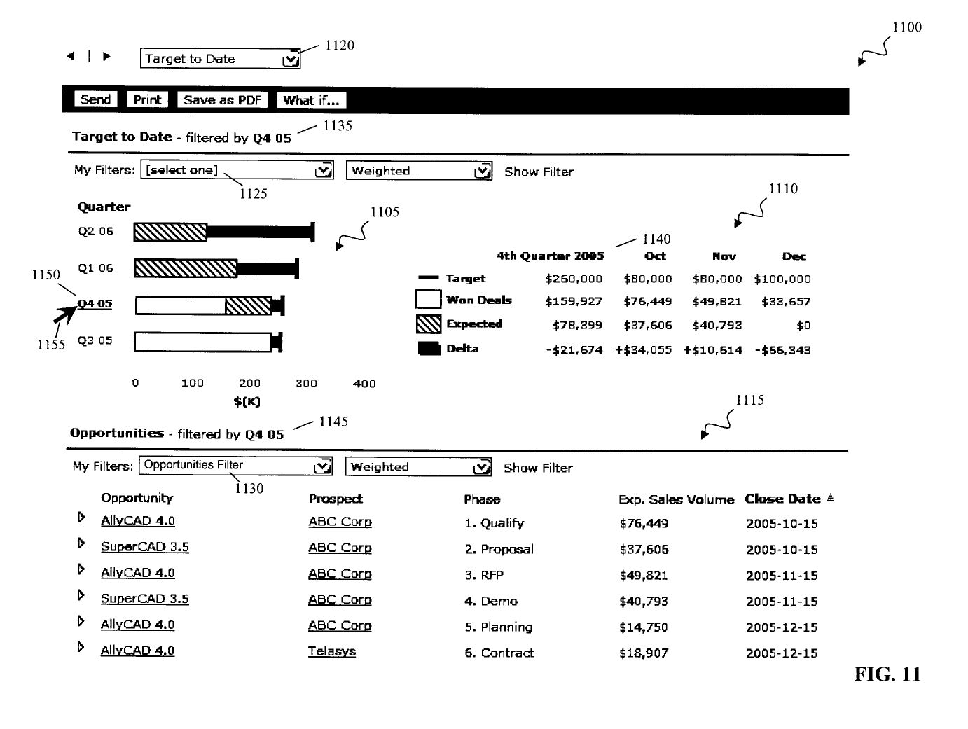

FIG. 11 shows another display screen 1100 on which filtered data can be rendered. Display screen 1100 includes renditions 1105, 1110, 1115 of various redactions of the information content of a data stream, namely, a “target to date” data stream, that is identified in a data stream identifier 1120. The information content of renditions 1105, 1110, 1115 is subject to increasingly strict criteria as additional filtering is performed. This filtering can be described in the rendition of descriptors of currently selected filters 1125, 1130 on display screen 1100. As another example, the filtering can be described by the rendition of output descriptors 1135, 1140, 1145 on display screen 1100.

The one or more of the filters described in output descriptors 1135, 1140, 1145 can be received as a consequence of user interaction with an interactive element displayed on display screen 1100. In the illustrated example, a user interacts with a label 1150 of graphical rendition 1105 using a cursor 1155. The portion of graphical rendition 1105 has a logical relationship with the “Q4 05” filter described in output descriptors 1135, 1140, 1145. In particular, label 1150 describes a value in a predicate of a filter that is used to filter the “target to date” data stream identified by data stream identifier 1120 (i.e., the filtered set of data has an attribute of occurring within the fourth quarter of the year 2005, as described by the value “Q4 05.”)

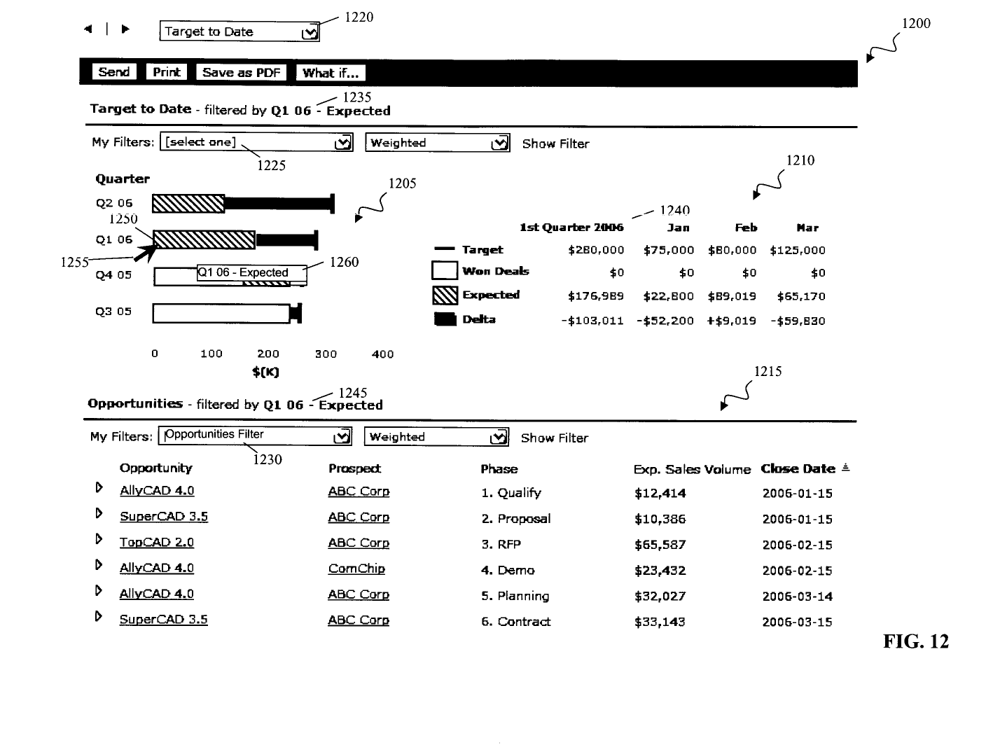

FIG. 12 shows another display screen 1200 on which filtered data can be rendered. Display screen 1200 includes renditions 1205, 1210, 1215 of various redactions of the information content of a data stream, namely, a “target to date” data stream, that is identified in a data stream identifier 1220. The information content of renditions 1205, 1210, 1215 is subject to increasingly strict criteria as additional filtering is performed. This filtering can be described in the rendition of descriptors of currently selected filters 1225, 1230 on display screen 1200. As another example, the filtering can be described by the rendition of output descriptors 1235, 1240, 1245 on display screen 1200.

The one or more of the filters described in output descriptors 1235, 1240, 1245 can be received as a consequence of user interaction with an interactive element displayed on display screen 1200. In the illustrated example, using a cursor 1255, a user interacts with a portion of a bar 1250 in graphical rendition 1205 that represents expected sales in the first quarter of 2006. A description 1260 of the filter evoked by interaction with bar portion 1250 can be displayed on display screen 1200.

Bar portion 1250 has a logical relationship with the “1st Quarter 2006” filter described in output identifier 1240 and the “Q1 06-Expected” filter described in output identifier 1245. In particular, the filtered set of data rendered in rendition 1210 can have an attribute of being in the first quarter of 2006, and the filtered set of data rendered in rendition 1215 can have an attribute of being expected in the first quarter of 2006. Thus, selections of multiple filters can be received as a consequence of user interaction with a single interactive element displayed on display screen 1200.

A number of implementations have been described. Nevertheless, it will be understood that various modifications may be made. For example, activities can be omitted or performed in different order and yet meaningful results achieved. Components can be omitted or rearranged and yet comparable function can be achieved. Accordingly, other implementations are within the scope of the following claims.

What is claimed is:

1. A display comprising:
a first visual rendition of at least a portion of a first collection of data, the first visual rendition comprising a first interactive element to receive a user selection of a first filter to be used to filter the first collection of data to yield a second collection of data; and
a second visual rendition of at least a portion of the second collection of data, the second visual rendition comprising a description of the first filter.

2. The display of claim 1, wherein the first visual rendition comprises a description of a filter that was used to filter a collection of data to yield the first collection of data.

3. The display of claim 1, wherein:
the visual rendition comprises a graph; and
the interactive element comprises a visual element in the graph.

4. The display of claim 3, wherein the visual element in the graph comprises a text label.

5. The display of claim 3, wherein the visual element in the graph comprises a representative element that represents a value or a variation of a variable.

6. The display of claim 1, wherein the first interactive element is logically related to an attribute of a predicate of the first filter.

7. The display of claim 6, wherein:
the first interactive element comprises a description of a variable; and
the attribute of the predicate of the first filter comprises the described variable.

8. The display of claim 1, wherein the first interactive element is logically related to a value of a predicate of the first filter.

9. The display of claim 6, wherein:
the first interactive element comprises a label; and
the value of the predicate of the first filter comprises the label.

10. The display of claim 1, wherein the second visual rendition comprises a tabular rendition.

11. The display of claim 1, wherein the description of the first filter comprises a description of a value of a predicate of the first filter.

12. The display of claim 1, wherein the description of the first filter comprises a description of an attribute of a predicate of the first filter.

13. The display of claim 1, wherein the display further comprises a third visual rendition of at least a portion of a third collection of data, the third collection of data yielded by filtering the second collection of data using a second filter.

14. The display of claim 13, wherein the user selection received by the first interactive element selects the first filter and the second filter.

15. An article comprising one or more machine-readable media storing instructions operable to cause one or more machines to perform operations, the operations comprising:
rendering at least a portion of a first collection of data in a first visual rendition that includes a first interactive element;
receiving a user selection of a first filter as a consequence of user interaction with the first interactive element;
filtering the first collection of data to yield a second collection of data; and
rendering at least a portion of the second collection of data in a second visual rendition, the second visual rendition comprising a description of the first filter.

16. The article of claim 15, wherein:
rendering the portion of the first collection of data comprises rendering a graph; and
receiving the user selection comprises receiving the user selection as a consequence of user interaction with a visual element in the graph.

17. The article of claim 16, wherein receiving the user selection comprises receiving the user selection as a consequence of user interaction with a text label in the graph.

18. The article of claim 16, wherein receiving the user selection comprises receiving the user selection as a consequence of user interaction with a representative element that represents a value or a variation of a variable.

19. The article of claim 16, wherein the first interactive element is logically related to a value of a predicate of the first filter.

20. The article of claim 19, wherein:
the first interactive element comprises a description of a variable; and
the value of the predicate of the first filter comprise the described variable.

21. The article of claim 16, wherein the first interactive element is logically related to an attribute of a predicate of the first filter.

22. The article of claim 21, wherein:
the first interactive element comprises a label; and
the attribute of the predicate of the first filter comprises the label.

23. The article of claim 19, wherein the operations further comprise:
filtering the second collection of data to yield a third collection of data; and
rendering at least a portion of the third collection of data in a third visual rendition.

24. The article of claim 23, wherein rendering at least the portion of the first collection, rendering at least the portion of the second collection, and rendering at least the portion of the third collection comprises rendering the portions on a same visual display.

25. The article of claim 23, further comprising receiving a user selection of the third filter.

26. The article of claim 23, wherein the user selection of the third filter is received as a consequence of the user interaction with the first interactive element.

27. A method comprising:
receiving a collection of data;
filtering the collection to yield a once-filtered collection of data;
rendering at least a portion of the once-filtered collection of data on a display;
filtering the once-filtered collection of data to yield a twice-filtered collection of data;
rendering at least a portion of the twice-filtered collection of data on the display;
filtering the twice-filtered collection of data to yield a thrice-filtered collection of data; and
rendering at least a portion of the thrice-filtered collection of data on the display.

28. The method of claim 27, wherein rendering at least a portion of the once-filtered collection, the twice-filtered collection, or the thrice-filtered collection comprising rendering the portion in a graphical display.

29. The method or claim 27, wherein:
rendering at least a portion of the once-filtered collection or the twice-filtered collection comprises rendering at least a portion of a data collection in a first visual rendition that includes a first interactive element;
the method further comprises receiving a user selection of a first filter as a consequence of user interaction with the first interactive element; and
rendering at least a portion of the twice-filtered collection or the thrice-filtered collection comprises rendering at least a portion of a data collection in a second visual rendition, the second visual rendition comprising a description of the first filter.
